(19) United States
(12) Patent Application Publication
(10) Pub. No.: US 2003/0045421 A1
(43) Pub. Date: Mar. 6, 2003

(54) Optical tellurite glasses for optical waveguide amplifiers and oscillators, and process for producing them

(75) Inventors: Herbert Burger, Jena (DE); Udo Grunke, Jena (DE); Ivallo Gugov, Jena (DE)

Correspondence Address: Paul D. Greeley, Esq., Ohlandt, Greeley, Ruggiero & Perle, L.L.P., 10th Floor, One Landmark Square, Stamford, CO, 06901-2682, US

(73) Assignee: Agilent Technologies, Inc.

(21) Appl. No.: 10/219,388

(22) Filed: Aug. 15, 2002

(30) Foreign Application Priority Data
Aug. 15, 2001 (DE) 10139904.9

(51) Int. Cl. C03C 3/12

(52) U.S. Cl. 501/41

(57) ABSTRACT

The present invention relates to optical tellurite glasses for optical waveguide amplifiers and oscillators, and process for producing them. The object was to provide, with a high yield, optical tellurite glasses for oscillators and optical waveguide amplifiers in planar and fiber form which have good melting and processing properties and a high crystallization stability and a low water content. This is achieved by a special glass composition (mol %):

| | |
|---|---|
| TeO₂: | 65-78 |
| ZnO: | 2-23 |
| PbO: | 1-23 |
| (where total ZnO + PbO | 15-25) |
| Nb₂O_{5:} | 0.5-12 |
| La₂O₃ and/or other rare earth oxides: | 0.2-8 |
| (where total Nb₂O₅ + La₂O₃ | 0.7-16) |
| Metal halides: | 0.5-3 |

where the components of the glass composition are mixed without water and hydrogen and are melted in a dry oxygen stream. Their good properties means that the tellurite glasses can be used as optical waveguides in the form of planar and fiber structures, optical waveguide amplifiers and laser glasses.

The invention relates to optical tellurite glasses and to a process for producing them. Their good properties means that the tellurite glasses can be used as optical waveguides in the form of planar and fibre structures, optical waveguide amplifiers and laser glasses.

Optical tellurite glasses have only been the subject of intensive research for about 30 years (e.g. M. Imaoka, T. Yamazaky: J. Ceram. Assoc. Japan 76, 1968, 160; H. Bürger, W. Vogel, V. Kozhukharov: IR Transmission and Properties of Glasses in the TeO₂—[RₙOₘ, RₙXₘ, Rₙ(SO₄)ₘ, Rₙ(PO₃)m and B₂O₃] Systems, Infrared Phys. 25, 1985, 395; M. J. Weber: J. Appl. Physics 52, 1981, 2944) and in the last 10 years have been used specifically as optical waveguide amplifiers, on account of their broad optical window in the NIR spectral region, for optical data transmission (Y. Ohishi, A. Mori, M. Yamada, H. Ono, T. Nishida, K. Oikawa: Gain characteristics of tellurite-based erbium-doped fiber amplifiers for 1.5 μm broadband amplification, Optical Letters 23, 1998, 274-76; J. S. Wang, E. M. Vogel, E. Snitzer: 1.3 μm emission of neodymium and praseodymium in tellurite-based glasses, J. Non-Cryst. Solids 178, 1994, 109-113; L. Le Neindre, T. Luo, B.-Ch. Hwang, J. Watson, S. Jiang: Erbium-doped tellurite glasses for 1.5 μm broadband amplification, SPIE Conference on Rare-Earth-Doped Materials and Devices III San Jose/Calif. 3622, 1999, 58-65; S. Tanabe, X. Feng, T. Hanada: Improved emission of Tm³⁺-doped glass for a 1.4-μm amplifier by radiative energy transfer between Tm³⁺ and Nd³⁺, Optics Letters 25 No. 11, 2000, 817-819).

Since the beginning of data transmission using optical waveguides, the amount of data which needs to be transmitted has risen enormously, in particular as a result of the Internet and other multimedia applications—and consequently there is a search both for new methods in data transmission technology and for new optical glass compositions for optical fibre amplifiers, in order to increase the bandwidth in DWDM (dense wavelength division multiplexing) technology by opening up new bands or widening existing bands in the NIR spectral region from 1 200 nm to 1 650 nm (optical windows II. and III. in optical fibres).

Tellurite glasses are of considerable scientific and technical interest on account of their low melting points, for reasons of the high refractive index, on account of the good IR transmission and as a result of the possible uses as optical fibres or for nonlinear optical equipment. They generally have low viscosities in the melting temperature range of the glasses and a rapid drop as the temperature decreases, on account of the chemical bonding in the TeO₂; therefore, these are what are known as “short” glasses.

Although tellurite glasses have a UV cutoff which has been shifted into the long-wave spectral region, like virtually all glasses they have a high absorption in the spectral region from 2 800 nm to 4 000 nm, caused by fundamental oscillations of differently bonded OH groups in the glass. The corresponding OH harmonics lie in the working range of the fibre amplifiers, lead to a high fundamental absorption and reduce the lifespan of the excited states of the doped rare earth ions through radiation-free transmissions (O. Humbach, H. Fabian, U. Grzesik, U. Haken, W. Heitmann: Analysis of OH absorption bands in synthetic silica, J. Non-Crystall. Solids 203, 1996, 19-26 or Y. Ohishi, A. Mori, M. Yamada, H. Ono, T. Nishida, K. Oikawa: Gain characteristics of tellurite-based erbium-doped fiber amplifiers for 1.5 μm broadband amplification, Optical Letters 23, 1998, 274-76).

Both the low viscosities and the high concentration of OH groups generally lead to high crystal growth rates (CGRs) in tellurite glasses, so that when the glass fibres are being drawn for use as optical waveguides, crystals which are formed in the fibre mean that a high radiation loss occurs. Therefore, the fibres have to be selected with a view to low losses, which entails a high level of outlay on metrology, or the entire glass batch may even be unusable. Consequently, however, production costs are relatively high.

A number of patent documents in which tellurite glass compositions are described as optical and acousto-optical glasses are already known:

DE 31 25 299 A1 (1982) in mol %: 2-96% TeO₂, 2-49% P₂O₅, 2-49% PbO and/or ZnO, 0-10% MgO, 0-47% CaO, SrO and BaO, 0-5% B₂O₃ or La₂O₃, 0-7% Bi₂O₃, 0-3% Nb₂O₅ and 0-2% TiO₂. Additionally (above 100% by weight, in % by weight): 0.1-5% As₂O₃ or CeO₂.

JP 62 00 30 42 (1987) in mol %: 60-85% TeO₂, 0-25% Li₂O, 0-35% Na₂O, 0-25% K₂O, 0-25% Rb₂O, 0-15% Cs₂O, 0-10% MgO, 0-5% CaO, 0-5% SrO, 1-30% BaO, 0-30% ZnO, 0-30% PbO, 0-5% La₂O₃+ZrO₂+TiO₂+Nb₂O₅+Ta₂O₅+WO₃, 1-25% K₂O+Rb₂O+Cs₂O and 1-30% (ZnO+PbO).

JP 62 12 89 46 (1987) in mol %: 10-85% TeO₂, 1-50% P₂O₅, 1-50% PbO, 0-30% Li₂O, 0-40% ZnO, 1-40% (Li₂O+ZnO), 0-30% Na₂O, 0-30% K₂O, 0-25% Rb₂O, 0-20% Cs₂O, 0-30% (Na₂O+K₂O+Rb₂O+Cs₂O), 0-20% MgO, 0-20% CaO, 0-20% SrO, 0-35% BaO, 0-35% (MgO+CaO+SrO+BaO), 0-5% Ta₂O₅, 0-20% Nb₂O₅, 0-20% (Ta₂O₅+Nb₂O₅), 0-15% SiO₂, 0-25% GeO₂, 0-30% B₂O₃, 0-10% Al₂O₃, 0-20% Sb₂O₃, 0-15% In₂O₃, 0-4% La₂O₃, 0-4% Y₂O₃, 0-4% Gd₂O₃, 0-4% Yb₂O₃, 0-4% ZrO₂, 0-10% Bi₂O₃, 0-20% TiO₂, and 0-7% WO₃.

U.S. Pat. No. 4,732,875 (1988) in % by weight: 10-80% TeO₂, 7.9-30% B₂O₃, 0-22% GeO₂, 7.9-30% B₂O₃+GeO₂, 5-35% La₂O₃, 0-18% Y₂O₃, 0-25% Gd₂O₃, 0-15% Yb₂O₃, 5-50% (La₂O₃+Y₂O₃+Gd₂O₃+Yb₂O₃), 0-20% Ta₂O₅, 0-26% Nb₂O₅, 1-26% Ta₂O₅+Nb₂O₅, 0-6% ZrO₂, 0-10% HfO₂, 0-30% ZnO, 0-20% BaO, 0-15% SrO, 0-15% CaO, 0-15% MgO, 0-20% BaO+SrO+CaO+MgO, 0-6% Li₂O, 0-6% Na₂O, 0-6% K₂O, 0-6% (Li₂O+Na₂O+K₂O), 0-15% SiO₂, 0-12% Al₂O₃, 0-10% Sb₂O₃, 0-10% In₂O₃, 0-15% Bi₂O₃, 0-35% PbO, 0-10% TiO₂, 0-25% WO₃.

U.S. Pat. No. 4,652,536 (1987) in mol %: 60-85% TeO₂, 0-25% Li₂O, 0-35% Na₂O, 0-25% K₂O, 0-25% Rb₂O, 0-15% Cs₂O, 1-25% (K₂O+Rb₂O+Cs₂O), 0-10% MgO, 0-5% CaO, 0-5% SrO, 1-30% BaO, 0-30% ZnO, 0-30% PbO, 1-30% (ZnO+PbO) and 0-5% (La₂O₃+ZrO₂+TiO₂+Nb₂O₅+Ta₂O₅+WO₃).

The above publications demonstrate in very general terms that the compositions of the tellurite glasses can be changed over a wide range. This leads to considerable variations in the physical properties. In general, tellurite glasses are characterized by high refractive indices, low softening points, relatively high chemical stability, relatively simple production and processing conditions.

The glasses described are intended for use in optical equipment, such as cameras, microscopes and telescopes, and for acousto-optical devices for light modulation and light deflection. The glass compositions listed do not contain any doping of rare earth oxides, which are required for fibre amplifiers. These are exclusively compact glasses with preferably different physical properties from those required in optical fibres for waveguide amplifiers. Therefore, the patents also do not give any information about the crystallization characteristics and quantitative data concerning the water content (OH group content) in the glasses, which is particularly important for glasses which are to be used for optical fibre amplifiers. There is also no stipulation concerning the provision of special optical tellurite glasses with a high yield which also have good melting and processing properties.

In more recent publications, tellurite glasses have been described specifically as fibre amplifiers and oscillators:

U.S. Pat. No. 5,251,062, 1993, Snitzer, et al., in mol %: 58-84% TeO₂, 0.05-24% R₂O (where R=Na, K, Rb, Cs, Tl and Ag), 10-30% QO (where Q=Zn, Be, Mg, Ca, Sr and Ba). The core glass is doped with relatively high concentrations of Er₂O₃, Yb₂O₃, Pr₂O₃, Nd₂O₃, Tm₂O₃ and Ho₂O₃. The glass is melted in a gold crucible at 800° C. for two hours under an air atmosphere. The exemplary embodiments relate mainly to glasses belonging to the TeO₂—ZnO—Na₂O system, the composition of which is also referred to as the ‘basic glass’.

J. S. Wang, E. M. Vogel, E. Snitzer, J. L. Jackel, V. L. da Silva and Y. Silberberg (Journal of Non-Crystalline Solids 178 [1994], 109-113) describe the abovementioned ‘basic glass’ doped with Nd³⁺ and Pr³⁺ ions. The glass was melted in a gold crucible at 800° C. for two hours in an atmosphere of dry oxygen and carbon tetrachloride.

The abovementioned alkali zinc tellurite glasses have a high fluorescence bandwidth, high refractive indices and consequently high absorption and induced emission cross sections. High concentrations of rare earth oxides were incorporated in the tellurite glasses. As a criterion for a good processing property in the production of fibres, the authors specify a relatively high difference between the transformation temperature and the crystallization temperature (Tₓ−T_{g}≅100 to 140° C.). This objective is desirable but is an insufficient criterion for high-quality optically active fibres. Important parameters with regard to crystallization, OH concentration and glass stability are once again not mentioned. However, our own tests have revealed that with the specified criteria it is impossible to achieve high crystallization stabilities and sufficiently low optical losses (as far as possible exclusion of water or OH groups) in the optically active fibre. Despite the presence of oxygen, the use of carbon tetrachloride leads to the undesirable reduction of TeO₂ in the glass and therefore to a reduction of the transmission in the fibre.

The following publications (A. Jha, S. Shen and M. Naftaly, Physical Review B, 62 [10], 2000, pages 6215-6227 and M. Naftaly, S. Shen and A. Jha, Applied Optics 39 [27], 2000, 4979-4984) likewise describe ‘basic glass’ compositions belonging to the TeO₂—ZnO—Na₂O system, doped with Er³⁺ and Tm³⁺ ions, in which, by using a dry melting atmosphere, it was possible to reduce the OH absorption in the IR region at approximately 3 350 nm from 12 dB/cm to only 7 dB/cm. Although this doubles the lifespan of the excited state of Er³⁺, it is not possible to further reduce the OH content in systems of glass compositions of this type.

This is also demonstrated in the publication (X. Feng, S. Tanabe and T. Hanada, Journal of Non-Crystalline Solids 281, 2001, 48-54), in which Er³⁺-doped TeO₂—GeO₂—ZnO—Na₂O—Y₂O₃ compositions were investigated. With four different melting variants of introduced dry gases, it was impossible to reduce the OH absorption to below 8 dB/cm.

Further publications were found:

JP 11 22 81 82 (1999) (Mimura et al., KDD), in mol %: 50-70% TeO₂, 2-15% GeO₂, 7-15% BaO and 7-25% ZnO (glass 1); 60-80% TeO₂, 5-20% BaO, 5-20% ZnO and 5-15% R2O (glass 2); 50-80% TeO₂, 5-20% ZnO and 15-40% PbO

JP 11 23 62 40 (1999) (Oishi et al., NTT), in mol %: 55-90% TeO₂, 0-35% ZnO, 0-35% Na₂O and 0-20% Bi₂O₃

U.S. Pat. No. 6,194,334 (2001) (Aitken et al., Corning Inc.), in mol %: 15-85% TeO₂, 5-55% WO₃, 0.5-40% R₂O (where R=Na, K or mixtures), 0.005-10% rare earth oxides, 0-30% MO (where M=Mg, Ca, Sr, Ba, Zn, Cd and/or Pb), 0-20% Y₂O₃ and/or Sb₂O₃ and 0-15% TiO₂, Nb₂O₅ and/or Ta₂O₅. These are alkali tungsten tellurite glasses with various types of additives. Some of the abovementioned oxides were replaced by corresponding halides, with the proportion of halides X/(X+O)<1/4. The R₂O/WO₃ ratio is greater than 1/3. The glasses may contain mixtures of light elements, such as B, H, P. These are oxidically bonded in the glass, which means that there is a high proportion of undesirable OH groups. The glasses were melted in a gold or quartz glass crucible at 750° C. for 30-60 minutes in an atmosphere of air. Like Snitzer et al., the authors give, as criterion for good processing properties for fibre production, the relatively high difference between transformation temperature and crystallization temperature (Tₓ−T_{g}≅100 to 143° C.).

Likewise on account of the high water content, a drawback of these glasses in the patents cited above is a high intensity loss in the optically active fibre. Moreover, the crystallization behaviour of these glasses is insufficiently characterized (only Tₓ−T_{g} is stipulated). As has already been mentioned, this criterion is a necessary but inadequate condition for high crystallization stability during the production of optically active glass fibres.

The publications which have been found substantially list alkali zinc tellurite glasses with small amounts of additives for use as fibre amplifiers. Important property criteria of the glasses for optical fibre production have not been specifically described. Also, possible changes to the composition have only been mentioned verbally and within very wide limits.

Therefore, it is an object of the present invention to provide, with a high yield, special optical tellurite glasses for oscillators and optical waveguide amplifiers in planar and fibre form which have good melting and processing properties and a high crystallization stability and a low water content.

According to the invention, this object is achieved by the following glass composition (mol %, based on oxide):

| | |
|---|---|
| TeO₂: | 65-78 |
| ZnO: | 2-23 |
| PbO: | 1-23 |
| (where total ZnO + PbO | 15-25) |
| Nb₂O_{5:} | 0.5-12 |
| La₂O₃ and/or other rare earth oxides: | 0.2-8 |
| (where total Nb₂O₅ + La₂O₃ | 0.7-16) |
| Metal halides: | 0.5-3, |

where the components of the glass composition are dried, preferably at approx. 400° C., and are mixed substantially without water and hydrogen and are melted in a dry oxygen stream, preferably for at least 90 min, at a maximum temperature of 950° C. with stirring.

It has been found that the resulting tellurite glasses having this special basic composition have very good melting and processing properties, a high crystallization stability and an advantageously low water content.

The crystallization stability of the tellurite glasses is characterized by very low CGRs, CGRₘₐₓ<10 μm/min. It was possible to demonstrate surprisingly low OH-group absorption of the glasses of less than 3.5 dB/cm at 3 200 nm.

To specifically influence the crystallization stability and to achieve a wide variation in the physical properties depending on the intended use of the tellurite glasses, it is possible for further additives to be added, such as up to 5 mol % Al₂O₃, up to 5 mol % Ga₂O₃, up to 10 mol % Ta₂O₅, up to 8 mol % R₂O (R=Li and/or K), up to 10 mol % Na₂O, up to 8 mol % MgO, up to 12 mol % BaO, up to 5 mol % Y₂O₃, up to 10 mol % CeO₂, up to 10 mol % WO₃, up to 6 mol % In₂O₃, up to 5 mol % Bi₂O₃, up to 5 mol % GeO₂ and up to 10 mol % P₂O₅. Other rare earth oxides, such as Er₂O₃, Tm₂O₃, Ho₂O₃, Yb₂O₃, Pr₂O₃, Dy₂O₃ and/or Nd₂O₃, may be admixed with or replace the La₂O₃.

The invention is to be explained in more detail below with reference to exemplary embodiments illustrated in the drawing, in which:

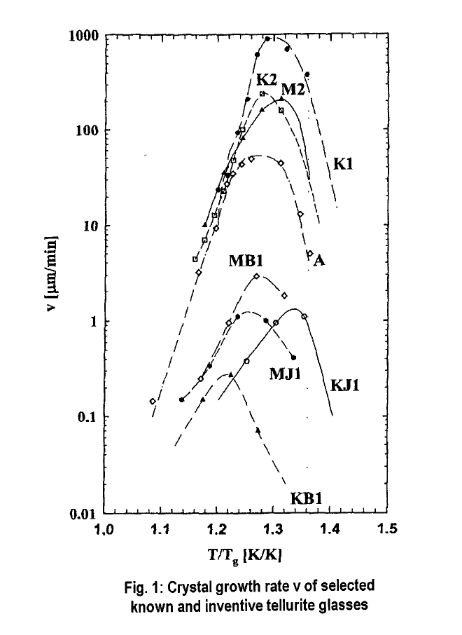

FIG. 1 shows a comparison of the crystal growth rate v of selected known and inventive tellurite glasses,

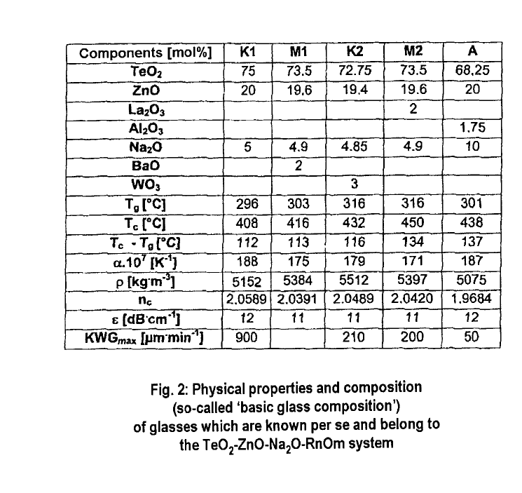

FIG. 2 shows physical properties and composition (so-called ‘basic glass composition’) of glasses which are known per se and belong to the TeO₂—ZnO—Na₂O=RₙOₘ system, the crystal growth rate of which is illustrated in FIG. 1,

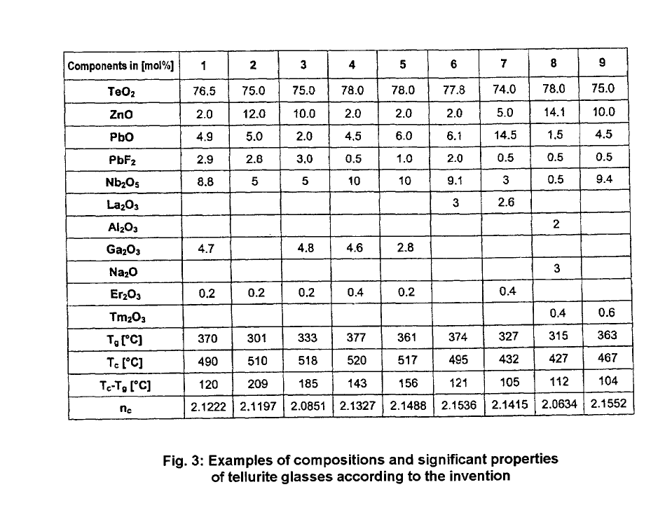

FIGS. 3/4: show examples of compositions and significant properties of tellurite glasses according to the invention.

An example is selected tellurite glasses which are suitable in particular for use as optical fibres in fibre amplifiers and oscillators. They were produced in the following way:

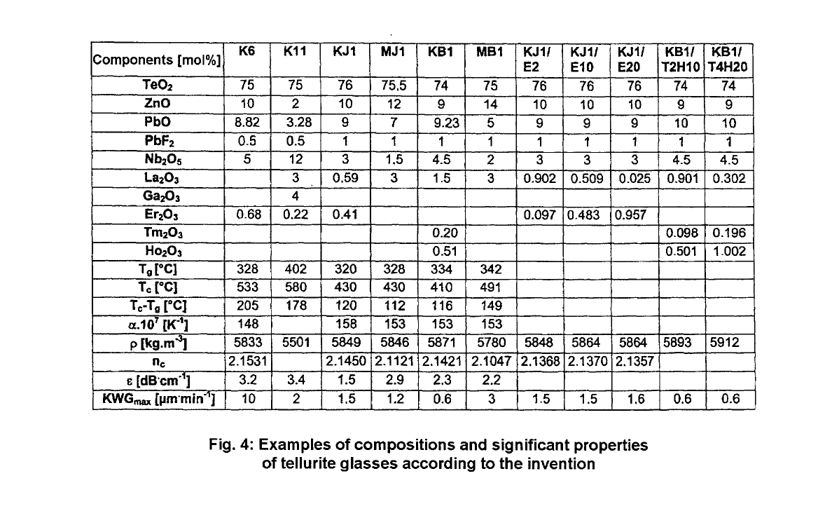

The substantially water-free, high-purity oxidic or nitrate-, sulphate-, phosphate-, carbonate- or halide-containing materials (all components initially weighing in at over 5 mol % with a purity of 99.999% and components weighing in at <5 mol % with a purity of 99.99%) were dried for 20 hours at 350-400° C. and used as starting materials for the glass composition. FIGS. 3 and 4 list the individual glass compositions (in mol %, based on oxide) together with significant properties of the tellurite glasses produced from each of these compositions in table form.

The powders corresponding to the respective compositions were melted in a gold or platinum crucible with the exclusion of moisture. To produce the bonded OH groups in the glass, the glass batch was previously conditioned at 450-500° C. for two to four hours under flowing oxygen (at least 1 l/min), which was highly dried by means of Zeosorb and P₂O₅. Then, the temperature was increased by 100° C. every half hour.

During the melting, the oxygen stream was maintained and the molten glass was homogenized. Depending on the composition, the glasses were clarified for one hour at 900-950° C.; then, the furnace temperature was reduced in steps (by 50° C. every half hour) to 800° C. The homogenized molten glass was then poured into a preheated (10° C. above T_{g}) brass casting mould with an internal diameter of 10 mm and a length of 150 mm (for preforms using the rod-in-tube drawing process). If an extrusion process is intended, brass casting moulds with larger internal diameters are used.

The cast glass is then subjected to precision cooling (<0.3° C./min) until it reaches room temperature. To monitor the optical and thermal properties, DTA, dilatometer, transmission and fluorescence measurements were carried out on some of the preforms.

FIG. 1 provides a comparison of the crystal growth rate of tellurite glasses with selected glass compositions from FIG. 4 (KJ1, MJ1, KB1 and MB1) with known tellurite glasses (K1, K2, M2, A), the composition of which (the so-called ‘basic glass composition’ belonging to the TeO₂—ZnO—Na₂O—RₙOₘ system) is listed in table form in FIG. 2.

In the lists in the tables, the abbreviations have the following meanings:

| | |
|---|---|
| T_{g} | transformation temperature [° C.] from (DTA, |
| | 10 K/min) |
| T_{c} | temperature of the crystallization maximum |
| | [° C.] (DTA, 10 K/min) |
| (T_{c}-T_{g}) | qualitative criterion for the |
| | crystallization stability [K] |
| α. 10⁷ | coefficient of linear thermal expansion |
| | [K⁻¹] at 10 K/min |
| ρ | density (kgm⁻³] |
| n_{c} | refractive index at λ_{643.84 nm} |
| ε | absorption coefficient [dB/cm] |
| | (λ = 3 200 nm) |
| CGRₘₐₓ | maximum crystal growth rate [μm/min] |

1. Optical tellurite glasses for optical waveguide amplifiers and oscillators, having a composition (mol %, based on oxide) of:

| | |
|---|---|
| TeO₂: | 65-78 |
| ZnO: | 2-23 |
| PbO: | 1-23 |
| (where total ZnO + PbO | 15-25) |
| Nb₂O_{5:} | 0.5-12 |
| La₂O₃ and/or other rare earth oxides: | 0.2-8 |
| (where total Nb₂O₅ + La₂O₃ | 0.7-16) |
| Metal halides: | 0.5-3. |

2. Optical tellurite glasses according to claim 1, characterized by the following additional constituents (mol %, based on oxide):

| | |
|---|---|
| Al₂O₃: | 0-5 |
| Ga₂O₃: | 0-5 |
| Ta₂O₅: | 0-10 |
| Li₂O: | 0-8 |
| Na₂O: | 0-10 |
| K₂O: | 0-8 |
| MgO: | 0-8 |
| BaO: | 0-12 |
| Y₂O₃: | 0-5 |
| WO₃: | 0-10 |
| In₂O₃: | 0-6 |
| Bi₂O₃: | 0-5 |
| GeO₂: | 0-5 |
| P₂O₅: | 0-10. |

3. Optical tellurite glasses according to claim 1, characterized in that the metal halides used are metal chlorides and/or fluorides, such as PbF₂, ZnF₂, PbCl₂ and ZnCl₂.

4. Optical tellurite glasses according to claim 1, characterized in that the La₂O₃ is partially or completely substituted by the other rare earth oxides, such as Er₂O₃, Tm₂O₃, Ho₂O₃, Yb₂O₃, Pr₂O₃, Dy₂O₃ and/or Nd₂O₃.

5. Optical tellurite glasses according to claim 4, characterized in that the other rare earth oxides, such as Er₂O₃, Tm₂O₃, Ho₂O₃, Yb₂O₃, Pr₂O₃, Dy₂O₃ and/or Nd₂O₃, are admixed with the La₂O₃ in a concentration of 0.005-5 mol %.

6. Process for producing the optical tellurite glasses according to one or more of the preceding claims, characterized in that the components of the glass composition are dried, preferably at approx. 400° C., and are substantially free of water and hydrogen, and are mixed and melted in a dry oxygen stream, preferably for at least 90 min, at a maximum temperature of 950° C. with stirring.

7. Process according to claim 6, characterized in that substantially water-free compounds, such as oxides, nitrates, carbonates, sulphates, phosphates and halides, are used as components of the glass composition.
